(19) United States
(12) Patent Application Publication
(10) Pub. No.: US 2022/0240652 A1
(43) Pub. Date: Aug. 4, 2022

(54) BULB TUBE HOLDER

(71) Applicant: Ronald B Collins, JR., Castle Rock, MN (US)

(72) Inventor: Ronald B Collins, JR., Castle Rock, MN (US)

(21) Appl. No.: 17/676,030

(22) Filed: Feb. 18, 2022

Related U.S. Application Data
(60) Provisional application No. 63/207,015, filed on Feb. 3, 2021.

(51) Int. Cl. A45F 3/02; F21V 19/04

(52) U.S. Cl. CPC A45F 3/02; A45F 2003/003; F21V 19/047

(57) ABSTRACT

A bulb tube holder and a method for installing or replacing a bulb tube in an overhead light fixture. The bulb tube holder includes a hollow cylindrical tube that can contain several bulb tubes. A cap secures a top opening of the hollow cylindrical tube. A shoulder strap coupled to the hollow cylindrical tube allows carrying the bulb tube holder on a shoulder. A fastening strap is also provided to secure the bulb tube holder to a supporting structure.

### CROSS-REFERENCE TO RELATED APPLICATIONS

This application claims priority from the U.S. provisional patent application Ser. No. 63/207,015, filed on Feb. 3, 2021, which is incorporated herein by reference in its entirety.

### FIELD OF INVENTION

The present invention relates to an elongated hollow tubular shape holder, and more particularly, the present invention relates to a holder for bulb tubes.

### BACKGROUND

Bulb tubes are generally installed on ceilings or the top portion of a wall. Depending upon the height of the ceiling or the wall, a person may reach an overhead bulb tube fixture using a ladder, step stool, scissor lift, mobile scaffold, or the like. Public places, such as sheds, stadiums, and the like generally have higher ceilings and multiple bulb tubes fixtures.

Installing or replacing the bulb tubes requires a person to reach up to the overhead fixture. Generally, a ladder is used because it is easily available. Bulb tubes being delicate in nature must be carefully handled. So, a second person is needed to hand over the bulb tube to a person already on the ladder or similar elevated platform, within reach of the overhead fixture.

However, the help of the second person may not always be available. Moreover, the services of the second person just to handle the bulb tubes can increase the overall cost of installation or replacement of bulb tubes. In the absence of the helper, the person must climb up and down several times to install several bulb tubes. Moreover, carrying a bulb tube in a hand while ascending and descending the ladder can be risky. In case of replacement of the bulb tube, the problem can double up as both the hands are occupied while installing the bulb tube and the old bulb tube must be placed on the ladder which is unstable, and the old bulb tube can fall.

Thus, a need is appreciated for a device that can aid a person in carrying bulb tubes up and down the ladder for installing or replacing the bulb tubes.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a holder for bulb tubes.

It is another object of the present invention that the holder can carry several bulb tubes together.

It is still another object of the present invention that the holder can comfortably be secured to a supporting structure or carried on a shoulder.

It is a further object of the present invention that the holder can be adjusted in length for the bulb tubes of different lengths.

It is still a further object of the present invention that the holder is economical to manufacture.

It is yet a further object of the present invention that the holder can provide cushioning against bumps.

### BRIEF DESCRIPTION OF THE DRAWINGS

The accompanying FIGURES, which are incorporated herein, form part of the specification and illustrate embodiments of the present invention. Together with the description, the FIGURES further explain the principles of the present invention and to enable a person skilled in the relevant arts to make and use the invention.

FIG. 1 is a perspective view of the bulb tube holder, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a bulb tube holder that allows carrying several bulb tubes safely up and down a ladder or a similar elevated platform for installing and replacing the bulb tubes to overhead light fixtures mounted on a ceiling or high on a wall. The disclosed bulb tube holder can protect the bulb tubes against light bumps and shocks. The disclosed bulb tube holder can make the process of handling and installing new bulb tubes and replacing old bulb tubes easier and safer. Moreover, a single person can now install and replace the bulb tubes without any help from a second person.

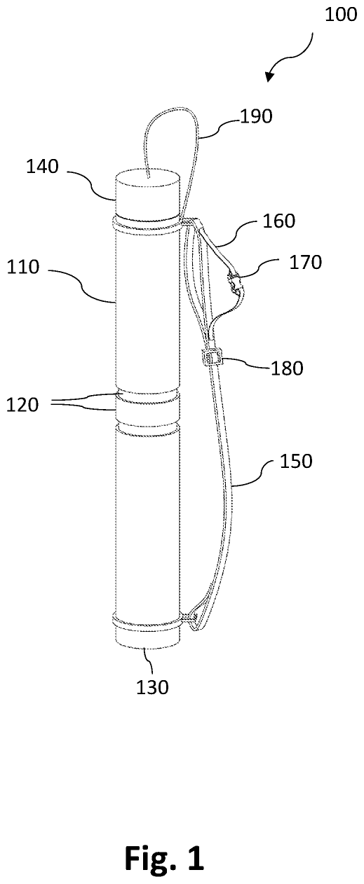

Referring to FIG. 1 which is a perspective view for the disclosed bulb tube holder 100. The disclosed bulb tube holder 100 can include a hollow cylindrical tube 110. The hollow cylindrical tube 110 can include multiple telescoping members 120 that allow adjusting a length of the hollow cylindrical tube. In one case, two or more telescoping members can allow adjust the length of the hollow cylindrical tube. In one case, the maximum length of the hollow cylindrical tube can be about 48-22 inches, i.e., more than a length of a standard bulb tube. In one case, the length of the hollow cylindrical tube can be about 49 inches long. A suitable locking mechanism (not shown) can be provided to limit the movement of the telescoping members to the desired length. Such locking mechanisms for use in telescoping tubes are known to a skilled person and any such locking mechanism can be used without departing from the scope of the present invention. The diameter of the hollow cylindrical tube can be such that to allow at least two bulb tubes to be freely encased within the hollow cylindrical tube. In one case, the diameter of the hollow cylindrical tube can be about 5 inches. The large diameter of the hollow cylindrical tube may allow carrying multiple new and old bulb tubes. The hollow cylindrical tube can be made from a durable material, such as plastics and metal. Preferably the material of the hollow cylindrical tube can be light in weight, such as aluminum is both light in weight and durable. Similarly, strong plastics can also be used that are both light in weight and durable.

A bottom cap 130 can close the hollow cylindrical tube. In one case, the bottom cap can have a cushioning material on both sides. The outer side cushioning material can act as a shock absorber against light bumps and shocks. The inner side cushioning material can provide cushioning for the bulb tubes. The out surface of the hollow cylindrical tube can be provided with an anti-skid material that can prevent slipping of the bulb tube holder from hand as well as a buffer against light bumps and shocks. Alternatively, suitable circumferential ribs can also be provided to prevent the slipping of the bulb tube holder from hands.

A top cap 140 can close an open top of the hollow cylindrical tube. The top cap can be similar to the bottom cap. Alternatively, the top cap can have a cushion only on the bottom side. The top cap can be removably coupled to the hollow cylindrical tube. For example, the top cap and the hollow cylindrical tube can have threads for screwing the top cap to the hollow cylindrical tube. Alternatively, the top cap can be secured using a snap-fit or friction fit mechanism. The top cap can also have suitable ribs on an outer surface to enhance the grip while twisting the top cap. A cord 190 can be coupled to the top cap and the hollow cylindrical body to prevent the top cap from falling.

A shoulder strap 150 can also be provided wherein one end of the shoulder strap can be coupled to the bottom of the hollow cylindrical tube. Near the top of the hollow cylindrical tube can be provided a hook that allows the free end of the shoulder strap to loop through and coupled to a webbing slider 180. The webbing slider can allow adjusting the length of the shoulder strap. For example, a tri-glide webbing slider can be used. While the illustration shows the hook near the top of the hollow cylindrical tube, it is obvious to a reader of this disclosure that the hook can also be provided near the bottom of the hollow cylindrical tube.

A fastening strap 160 can also be provided near the top of the hollow cylindrical tube. The fastening strap can be fastened to a support structure for safely securing the bulb device holder. For example, the supporting structure can be a rung of a ladder, lift cage, or any supporting structure within a reach of the person. The fastening strap can have a fastener 170, such as a hook and loop fastener, squeeze buckle, and the like. The fastening strap can be coupled to the hollow cylindrical tube. Alternatively, the fastening strap can be coupled to a top portion of the shoulder strap i.e., a portion of the shoulder strap near the top cap.

In use, a person can put several bulb tubes in the disclosed bulb tube holder. In the case of replacing an old tube, at least a space of one bulb tube can be kept empty. The bulb tube holder can be carried on the shoulder of a person. The person can climb up the ladder and both hands can remain free while climbing up the ladder to reach an overhead light fixture. Once reached, the disclosed bulb tube holder can be secured to a supporting structure using the fastening strap. Thereafter, the person can remove the old bulb tube from the overhead light fixture, and put the old bulb tube in the disclosed bulb tube holder after twist opening the top cap. Thereafter, a new bulb tube can be taken out from the disclosed bulb tube holder and installed by the person. When done, all the old tubes can be safely put inside the disclosed bulb tube holder, the disclosed bulb tube holder can be unfastened from the supporting structure, hung to the shoulder, and the person can then safely descend from the ladder while hands can be free to hold the ladder.

Thus, a person can safely ascend and descend a ladder while both hands remain free for grasping the ladder. Also, the bulb tubes can be safe while carrying on the latter and while installing. Multiple tubes can be installed or replaced without climbing up and down several times and without the help of a second person.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for installing or replacing a bulb tube in an overhead light fixture, the method comprising the steps of:
providing a bulb tube holder comprising:
a hollow cylindrical tube having a proximal end and a distal end, the hollow cylindrical tube configured to contain a plurality of bulb tubes,
a top cap removably coupled to an open-top of the hollow cylindrical tube,
a shoulder strap coupled at one end to the proximal end of the hollow cylindrical tube and another end of the shoulder strap coupled to the distal end of the hollow cylindrical tube, and
a fastening strap coupled to the proximal end of the hollow cylindrical tube.

2. The method according to claim 1, wherein the method further comprises the steps of:
putting one or more bulb tubes in the bulb tube holder;
carrying the bulb tube holder on a shoulder by a person through the shoulder strap;
ascending on an elevated platform to reach an overhead fixture;
removing a bulb tube of the one or more bulb tubes from the bulb tube holder; and
installing the bulb tube on the overhead fixture.

3. The method according to claim 2, wherein the method further comprises the steps of:
upon ascending, securing the bulb tube holder to a supporting structure through the fastening strap.

4. The method according to claim 2, wherein the method further comprises the steps of:
upon installing, securing the top cap;
upon securing, hanging the bulb tube holder on the shoulder through the shoulder strap; and
descending from the elevated platform.

5. The method according to claim 3, wherein the method further comprises the steps of:
upon installing, unfastening the fastening strap;
securing the top cap;
upon securing, hanging the bulb tube holder on the shoulder through the shoulder strap; and
descending from the elevated platform.

6. The method according to claim 1, wherein the method further comprises the steps of:
putting one or more bulb tubes in the bulb tube holder;
carrying the bulb tube holder on a shoulder by a person through the shoulder strap;
ascending on an elevated platform to reach an overhead fixture;
upon ascending, removing an old bulb tube from the overhead fixture;
putting the old bulb tube in the bulb tube holder and then the bulb tube is removed;
removing a bulb tube of the one or more bulb tubes from the bulb tube holder; and
installing the bulb tube on the overhead fixture.

7. The method according to claim 1, wherein the hollow cylindrical tube is telescoping and comprises a plurality of telescoping members.

8. The method according to claim 7, wherein the telescoping hollow cylindrical tube can extend up to 52 inches in length.

9. A bulb tube holder for installing or replacing a bulb tube in an overhead light fixture, the bulb tube holder comprising:
a hollow cylindrical tube having a proximal end and a distal end, the hollow cylindrical tube configured to contain a plurality of bulb tubes;
a top cap removably coupled to an open-top of the hollow cylindrical tube;
a shoulder strap coupled at one end to the proximal end of the hollow cylindrical tube and another end of the shoulder strap coupled to the distal end of the hollow cylindrical tube; and
a fastening strap coupled to the proximal end of the hollow cylindrical tube.

10. The bulb tube holder according to claim 9, wherein the hollow cylindrical tube is telescoping and comprises a plurality of telescoping members.

11. The bulb tube holder according to claim 10, wherein the telescoping hollow cylindrical tube can extend up to 52 inches in length.
